(19) United States
(12) Patent Application Publication
(10) Pub. No.: US 2020/0361353 A1
(43) Pub. Date: Nov. 19, 2020

(54) FOLDING TABLE FOR A MOTOR VEHICLE

(71) Applicant: Brose Fahrzeugteile SE & Co. Kommanditgesellschaft, Coburg, Coburg (DE)

(72) Inventors: Denis SCHMIDT, Berlin (DE); Ridvan YALCIN, Günzburg (DE)

(73) Assignee: Brose Fahrzeugteile SE & Co. Kommanditgesellschaft, Coburg, Coburg (DE)

(21) Appl. No.: 16/766,023

(22) PCT Filed: Nov. 13, 2018
(86) PCT No.: PCT/EP2018/081053

§ 371 Date: May 21, 2020

(30) Foreign Application Priority Data
Nov. 22, 2017 (DE) 10 2017 220 863.5

(51) Int. Cl. B60N 3/00

(52) U.S. Cl. CPC B60N 3/002; B60R 2011/0082

(57) ABSTRACT

A folding table for a motor vehicle comprising a folded state and an unfolded state and comprising a plurality of segments each having an upper side, wherein in the unfolded state the upper sides of the segments jointly form a storage surface and extend between two outer lateral edges, which in the unfolded state include an angle greater than in the folded state. It is provided that in the folded state the segments lie one on top of the other such that at least the upper sides and/or the undersides of two segments face each other. In this way a stable folding table is provided, which is particularly compact in the folded state.

### CROSSREFERENCE TO RELATED APPLICATIONS

This application is the U.S. National Phase of PCT Application No. PCT/EP2018/081053 filed on Nov. 13, 2018, which claims priority to German Patent Application No. DE 10 2017 220 863.5, filed on Nov. 22, 2017, the disclosures of which are hereby incorporated in their entirety by reference herein.

### TECHNICAL FIELD

The present disclosure relates to a folding table for use in a motor vehicle.

### BACKGROUND

A folding table may have an unfolded state and a folded state and comprises a plurality of segments which are movable relative to each other. The segments each form a flat upper side. In the unfolded state of the folding table, the upper sides of the segments together form a substantially planar storage surface for depositing items such as beverage containers. In the unfolded state, the upper sides of the segments extend between two outer lateral edges, e.g. from two outer segments. The two outer lateral edges include an angle between them, which in the unfolded state is greater than in the folded state of the folding table.

### SUMMARY

One or more objects of the present disclosure may be to provide a folding table as stable as possible and compact in the folded state.

According to one or more embodiments, it is provided that in the folded state some or all segments lie one on top of the other such that at least the upper sides of two, such as adjacent segments face each other and/or that at least the undersides (each opposite the upper sides) of two, such as adjacent segments face each other.

It thereby is possible to fold up the folding table to a compact form. Nevertheless, the folding table may have a very high stability due to the suspension of the upper sides between the lateral edges. It also is possible to pivotally connect the segments to each other, which further improves the stability. In the folded state, the largest spatial axis of the space occupied by the folding table is (substantially) smaller than in the unfolded state. In the folded state, for example the upper sides of the segments are arranged in parallel planes offset from each other (in the direction of the normal).

In the unfolded state of the folding table, at least one point on one of the two outer lateral edges may have a larger distance to at least one point on the other one of the two outer lateral edges than in the folded state.

The folding table may include two, three or more segments, e.g. four, six or eight segments. An even number of segments may provide symmetrical folding.

The segments each may form at least one lateral edge. The segments may be pivotally connected to each other at adjoining lateral edges, e.g. by means of a hinge and/or by interposition of an intermediate piece. It may be provided that in the unfolded state of the folding table the segments and/or the upper sides of the segments are arranged around a common point and together form the storage surface.

In the folded state, as compared to the unfolded state, the segments may be pivoted or folded relative to each other in alternating directions. Expressed in other words, the folding table may be configured such that on folding up from the unfolded state into the folded state the segments pivot relative to each other in alternating directions. In the folded state, the upper sides of at least two segments may face each other and the undersides of at least two segments may face each other.

In the folded state, the segments may be folded up according to a zigzag folding. This may provide for a compact folded state. From the zigzag folding, the folding table may be unfolded relatively easily.

The arrangement around a common, such as a concentric point provides for the fact that the folding table may be folded and unfolded according to the principle of a fan (such as according to the principle of a folding fan). This permits a central and stable bearing of the folding table and may provide a relatively simple mechanism for folding and unfolding the folding table. In the unfolded state, the upper sides and/or the lateral edges of the segments may be arranged in the form of a fan.

The unfolded storage surface and/or the upper side of one or more, such as of all segments each e.g. have the shape of a circular sector or a triangle.

As an example, it may be provided that the storage surface of the unfolded folding table is substantially semicircular in shape. As an alternative to a semicircle, the segments and/or their upper sides in the unfolded state may be arranged according to a quarter circle, a three-quarter circle, a full circle or another circular sector around the circle center (of the corresponding full circle) as a common point.

The segments may include pivotal connections at adjacent lateral edges (such as in the unfolded state). For example, the segments therefor are positively connected to each other at their lateral edges, e.g. by means of a hinge. There may also be provided a film hinge between adjacent segments. Alternatively or in addition, a textile may connect two adjacent lateral edges.

At least one segment, such as two segments, may be pivotally articulated to a base. The base for example serves for easily mounting the folding table to the motor vehicle.

In a development a shifting element shiftable with respect to the base is provided, to which at least one connecting member is pivotally articulated, such as two connecting members are pivotally articulated. Each connecting member may be pivotally connected to a segment articulated to the base, such as at a point spaced apart from the base. In this way, a simple opening mechanism may be provided. The storage surface extends between two outer segments. One connecting member each may be pivotally connected to one of the two outer segments. A change of the angle between the two arms effects (in a particularly simple and comfortable way) folding up or unfolding of the folding table.

The folding table may include a drive unit by means of which the folding table may be comfortably transferred from the folded state into the unfolded state, and vice versa. For this purpose, an electric motor may be used for example. The drive unit for example effects a displacement of the shifting member with respect to the base.

Several or all segments may have the same shape and/or size. The segments thereby may be folded up to save space.

In one embodiment, at least one of the segments may include a textile which provides at least one portion of the upper side of the segment. This may reduce the weight of the folding table.

In one or more embodiments, a vehicle interior lining may include a folding table according to any of the embodiments described herein. Such a vehicle interior lining for example forms part of a dashboard, a center console, a door panel, a lateral area of a trunk, a vehicle seat or the like. Due to the compact folded state of the folding table, only little space is required for the vehicle table at or in the vehicle interior lining. Thus, the folding table can be arranged on parts or points of the vehicle interior lining at which a table has not been possible so far or possible only with corresponding adaptations of the vehicle interior lining.

As an example, the vehicle interior lining may include a receptacle that may be configured to accommodate the folding table in the folded state. When the folding table is not needed, it may thus be stowed in the receptacle and does not take up any room in the vehicle interior space.

According to one or more embodiments, a motor vehicle including the folding table and/or a vehicle interior lining according to any of the embodiments described herein, is provided. The motor vehicle thus can provide a particularly space-efficient interior space.

### BRIEF DESCRIPTION OF THE DRAWINGS

The idea underlying the invention will be explained in detail below with reference to the exemplary embodiments illustrated in the Figures, in which:

FIG. 1 shows a view of the upper side of an exemplary embodiment of a folding table in an unfolded state;

FIG. 2 shows a view of the underside of the folding table of FIG. 1 in the unfolded state;

FIG. 3 shows a view of the underside of the folding table of FIGS. 1 and 2 in a partly folded state;

FIG. 4 shows a sectional representation of the folding table of FIGS. 1-3 in a folded state;

FIG. 5 shows a schematic representation of a motor vehicle comprising a vehicle interior lining with a built-in folding table in an extended and partly unfolded state;

FIG. 6 shows the motor vehicle of FIG. 5 with the folding table in the unfolded state;

FIGS. 7A and 7B show various views of an exemplary embodiment of several segments of a folding table with integrated receptacles and limiters in the unfolded state;

FIG. 8 shows a front view of the segments of a folding table with limiters in the folded state;

FIG. 9A shows the segments of the folding table of FIGS. 1-4 with an additional fixing function;

FIG. 9B shows the segments of the folding table with an additional fixing function; and

FIG. 10 shows a front view of an exemplary embodiment of a plurality of segments comprising a textile.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

DE 696 03 063 T2 relates to a tabletop comprising a plurality of segments in the form of oblong elements having longitudinal side faces articulated to each other, whose upper sides are arranged around a common point in a position of use. The tabletop is shiftable between a retracted position in a vehicle door and the extended position of use outside the vehicle door, wherein the segments are pushed downwards from the horizontal around a curve. A comparatively large tabletop thereby can be stowed in the flat vehicle door. The necessary installation space for stowing the tabletop in the retracted state, however, is too large for many applications and installation sites in the motor vehicle, in particular extends over too large an area.

DE 35 23 393 A1 describes a travel table for a motor vehicle, which includes at least three parts at least partly overlapping each other and movable against each other approximately in the same plane. In the retracted state the parts serving as segments lie on top of each other and can be stowed in a compact installation space. In the extended state the segments form a common storage surface, and two outer lateral edges, between which the storage surface extends, are arranged at a larger angle to each other than in the retracted state. To extend the travel table, the segments are telescopically shifted in a plane parallel to the storage surface. However, as the segments are shiftable relative to each other, an unstable construction is obtained, which on extension and retraction also tends to canting. Furthermore, overlapping surfaces are necessary, which lead to an increased material requirement.

In particular in the automotive sector it is decisive to reduce the weight and the necessary installation space as far as possible. Especially due to the movements in the vehicle it also is important to provide a construction as stable as possible.

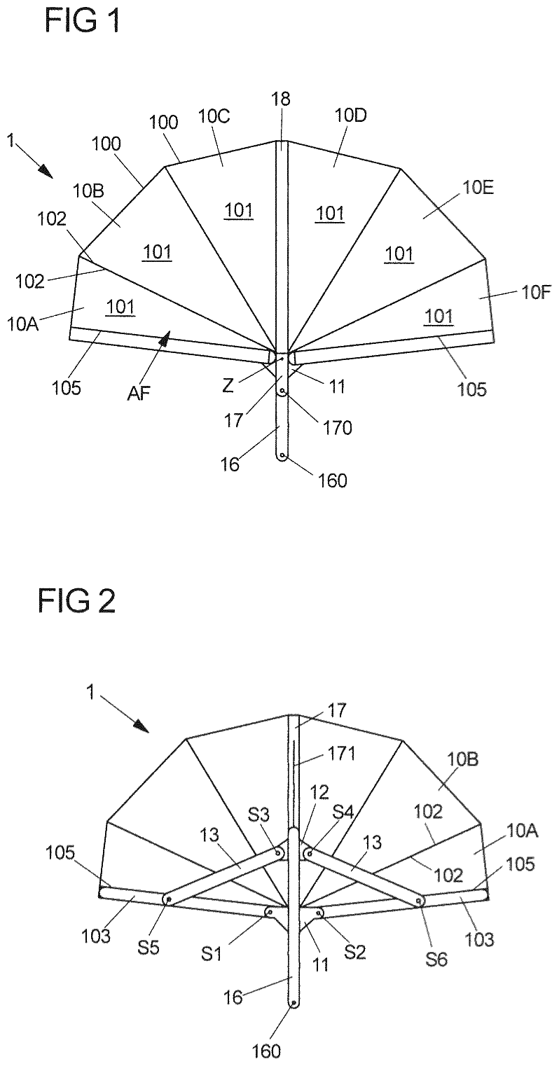

FIGS. 1 and 2 show a folding table 1 with a view of its upper side (FIG. 1) and of its underside (FIG. 2) opposite the upper side. The folding table 1 can be unfolded from a folded state into an unfolded state, and can be folded up from the unfolded state into the folded state. FIGS. 1 and 2 show the folding table in the unfolded state in which the folding table 1 on its upper side provides a storage surface AF for depositing objects, e.g. beverage containers and/or mobile phones. The storage surface AF is planar or substantially planar.

The folding table 1 may include a plurality of segments 10A-10F as folding elements, in the present example six segments 10A-10F. The segments 10A-10F are fabricated from a rigid material, e.g. from a plastic material, metal sheet, or from wood.

The segments 10A-10F each have an at least chiefly planar upper side 101 and an underside 104 opposite the upper side 101. The segments 10A-10F are flat. The upper side 101 and the underside 104 form the two largest surfaces of each of the (such as plate-shaped) segments 10A-10F. The upper side 101 and the underside 104 extend parallel to each other. In the unfolded state, the upper sides 101 of the segments 10A-10F are aligned in the same plane and form the storage surface AF.

The upper sides 101 (and/or the undersides 104) of the segments 10A-10F each are triangular, wherein other shapes, e.g. the shape of a circular sector, also are conceivable. The segments 10A-10F hence can be configured e.g. as a prism with a triangular base area or in the form of a piece of cake or pizza.

In the unfolded state, the segments 10A-10F are arranged around a concentric point Z. A tip of the triangular surfaces 101 points in the direction of the concentric point Z. In the unfolded state, the segments 10A-10F are arranged such that the storage surface AF jointly formed by their surfaces 101 substantially is semicircular or can be described by a semicircle. A first segment 10A and a last segment 10F each form the beginning and the end of the semicircle in a direction extending around the concentric point. The first and the last segment 10A, 10F represent the outer segments of the folding table 1.

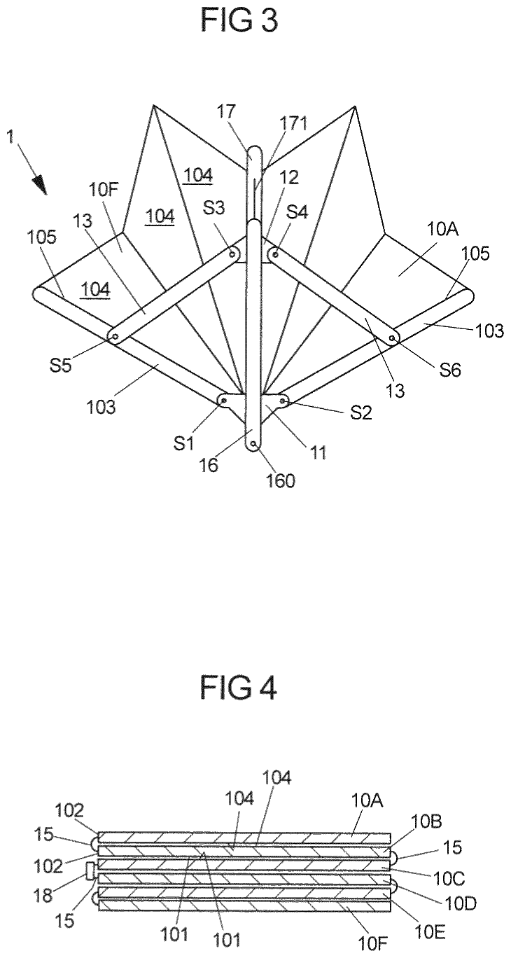

In the unfolded state, the storage surface AF extends between two outer lateral edges 105. The storage surface AF extends from the one outer lateral edge 105 to the second outer lateral edge 105. The storage surface AF is defined by the outer lateral edges 105 and by outer edges 100 of the segments 10A-10F which connect the outer lateral edges 105 to each other. In the unfolded state, the lateral edges 105 are (substantially) aligned towards a concentric point Z. Adjacent to the concentric point Z, the two outer lateral edges 105 adjoin each other. In the present case, the outer lateral edges 105 are (substantially) rectilinear. In the unfolded state (see FIGS. 1 and 2) the two outer edges 105 include an angle greater than in the folded state (see for example the partly folded state as shown in FIG. 3). For example, in the folded state the outer lateral edges 105 are aligned parallel (or substantially parallel) to each other. It can be provided that in the folded state the outer lateral edges 105 include an angle of less than 20°, less than 5° or of about 0° between them. In this way, a tight or particularly tight packing of the folded folding table can be achieved. In the unfolded state, the angle between the outer lateral edges 105 is e.g., greater than 20°, such as greater than or equal to 90° or 180°.

To unfold the folded folding table 1, the outer lateral edges 105 are pivotable relative to each other. The corresponding pivot axis extends e.g. through the concentric point Z and/or extends perpendicularly to the storage surface AF in the unfolded state.

Respectively adjacent segments 10A-10F are pivotally mounted to each other. In the unfolded state, the corresponding pivot axes extend parallel to the storage surface AF. Concretely, a hinge 15 each is provided between two adjacent segments 10A-10F, as illustrated for example in FIG. 4, which shows the folded state of the folding table 1.

The hinge 15 connects adjacent and mutually parallel lateral edges 102 of the adjacent segments 10A-10F. The hinge 15 for example is a positive, pivotable connection or a film hinge or a piece of textile connected to both adjacent segments 10A-10F. The hinge 15 permits pivoting of the adjacent segments 10A-10F by 180° or by approximately 180°. The lateral edges 102 connected by means of the hinges 15 substantially are aligned towards the concentric point Z. The lateral edges 102 each are connected by an outer edge 100. The outer edges 100 of the segments 10A-10F together with the outer lateral edges 105 of the outer segments 10A, 10F form the edge of the storage surface AF.

On the underside of the folding table 1 a mechanism for folding up and unfolding the folding table 1 is arranged. The mechanism may include a base 11 and a shifting element 12 shiftable with respect to the base. The base 11 is arranged at the concentric point Z or adjacent thereto. The outer segments 10A, 10F of the folding table 1 are pivotally articulated to the base 11, in the present example about two mutually parallel pivot axes S1, S2. Concretely, two arms 103 are pivotally mounted to the base at the two pivot axes S1, S2. The outer segments 10A, 10F each are mounted to the arms 103. In the present case, the arms 103 are oblong and each pivotally connected to the corresponding outer segments 10A, 10F. In the illustrated example, the arms 103 each are pivotally connected to the outer lateral edge 105 of the corresponding outer segments 10A, 10F about their longitudinal axis (or an axis parallel thereto).

A rod 17 (or generally a supporting element) is firmly connected to the base 11. A further rod 16 (or generally a further supporting element) is firmly connected to the shifting element 12. The two oblong rods 16, 17 are aligned parallel to each other. The rods 16, 17 are shiftable relative to each other along their longitudinal axes. In the present case, the rod 16 attached to the shifting element 12 is longitudinally shiftably mounted to the rod 17 attached to the base 11, in the illustrated example by means of a guide 171 (e.g., in the form of a guide rail), which here is arranged on the rod 17 attached to the base 11. By means of the guide 171 the rod 16 attached to the shifting element 17 is guided in the retracting and extending movement.

In the unfolded state, the rod 17 (generally the supporting element) attached to the base 11 supports one or more segments 10C, 10D. In the present case, an optional intermediate piece 18 is provided, which pivotally connects the two middle segments 10C, 10D to each other. In the unfolded state, the intermediate piece 18 rests on the rod 17 of the base 11. Alternatively or in addition, it can be provided that one or more segments, for example the middle segments 10C, 10D rest on the rod 17 (the supporting element) of the base 11.

Two connecting members 13 are pivotally articulated to the shifting element 12, in the present example about mutually parallel pivot axes S3, S4. Each of the connecting members 13 is pivotally connected to one of the arms 103, namely at corresponding (and mutually parallel) pivot axes S5, S6. The pivot axes S5, S6 of the connecting members 13 at the arms 103 are spaced apart from the pivot axes S1, S2 of the arms 103 at the base 11. The pivot axes S5, S6 of the connecting members 13 at the arms 103 also are spaced apart from the pivot axes S3, S4 of the connecting members 103 at the shifting element 12.

In the following, the functionality of the folding table 1 on transfer from the unfolded state as shown in FIGS. 1 and 2 via a partly folded state as shown in FIG. 3 into the folded state as shown in FIG. 4 will be explained.

The shifting element 12 is displaced with respect to the base 11 manually or by means of a drive unit, in concrete terms the fixed rod 16 of the shifting element 12 is shifted along its longitudinal axis. The distance of the shifting element 12 to the base 11 thereby is increased. The connecting members 13 thereby pull the arms 103 together (whose angle to each other becomes smaller). The segments 10A-10F pivot with alternating directions so that the segments 10A-10F fold up corresponding to a zigzag folding. For this purpose, the hinges can be pretensioned, e.g. by means of springs. Alternatively, the pivotability of the adjacent segments 10A-10F relative to each other from the unfolded state into the folded state can be blocked in one direction and be enabled only in the other direction, e.g. by means of a protrusion on at least one segment 10A-10F.

The optional intermediate piece 18, which divides the folding table 1 in two halves and in the unfolded state extends along the rod 17 of the base 11, makes folding up easier.

The shifting element 12 and the base 11 are shifted relative to each other until the segments 10A-10F lie one on top of the other. Upper sides 101 and undersides 104 of adjacent segments 10A-10F each alternately face each other and optionally are in full-surface contact with each other for a particularly tight packing. The folded state is shown in FIG. 4, wherein the mechanism of the folding table 1 is not shown in the simplified representation.

To unfold the folding table 1 from the folded state, the shifting element 12 is shifted towards the base 11. The connecting members 13 thereby press against the arms 103, whereby their angle to each other is increased (from about 0° to about 180°). The segments 10A-10F are unfolded like a fan and placed in one plane. Due to the fact that the segments 10A-10F are connected to each other via their lateral edges, the folding table 1 has a particularly high stability. The arms 103 and the rod 17 of the base 11 additionally contribute to the stability. It can be provided that in the unfolded state a force is exerted on the arms 103 by means of the shifting element 12 via the connecting members 13, in order to tension the segments 10A-10F.

On the rods 16, 17 (at their ends) a fixing point each is provided. At the fixing points 160, 170 mutually displaceable parts of a drive unit can be mounted. The displacement of these parts against each other folds or unfolds the folding table 1. The joint displacement of the parts moves the folding table 1, e.g. with respect to the drive unit and/or a receptacle.

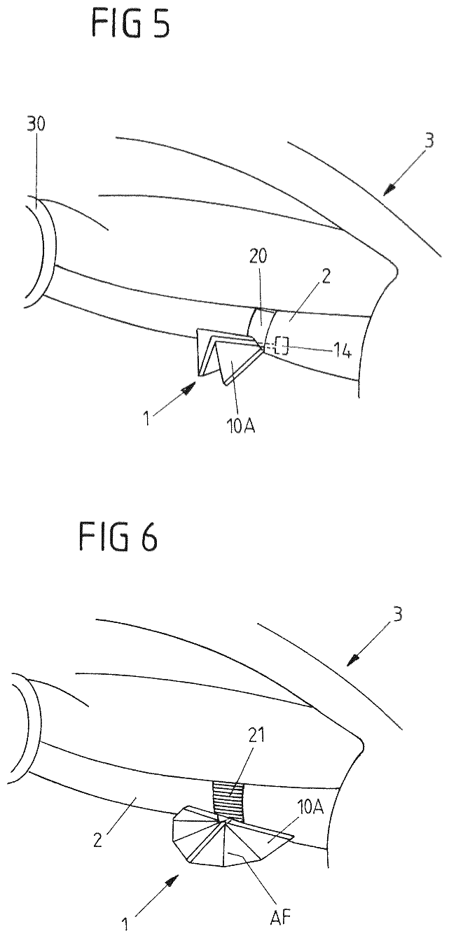

FIGS. 5 and 6 show the folding table of FIGS. 1 to 4 mounted on a vehicle interior lining 2 of a motor vehicle 3 with a steering wheel 30.

In the present case, the vehicle interior lining 2 is a dashboard. In the vehicle interior lining 2 (here on the passenger side) a receptacle 20 is formed. The receptacle 20 can be closed by means of an optional closure 21, here in the form of a sliding door. In the non-illustrated folded and stowed state, the folding table 1 is folded up and accommodated in the receptacle 20. The closure is closed and the folding table 1 is not visible.

When the folding table 1 is to be unfolded, the closure 21 first is opened, e.g. by means of a motor or manually. Thereupon, a drive unit 14 moves the folding table 1 in the folded state out of the receptacle 20. For this purpose, two rods 16, 17 (supporting elements) for example are jointly moved out of the receptacle 20. As soon as the folding table 1 has moved out of the receptacle 20 far enough, the drive unit 14 displaces the shifting element 12 with respect to the base 11 by means of the rods 16, 17. The folding table 1 thereby is unfolded in the way described above so that it provides the storage surface AF for depositing objects (see FIG. 6). The closure 21 can be closed.

The folding table 1 has been described in connection with FIGS. 1 to 6 to have a storage surface AF approximately spanning a semicircle. Alternatively, however, another shape of the folding table can of course also be provided, e.g. by using more or less segments and/or segments with a larger or smaller angle between the lateral edges. For example, the folding table can form a storage surface which approximately describes a circle, or a storage surface which only describes for instance a quarter circle.

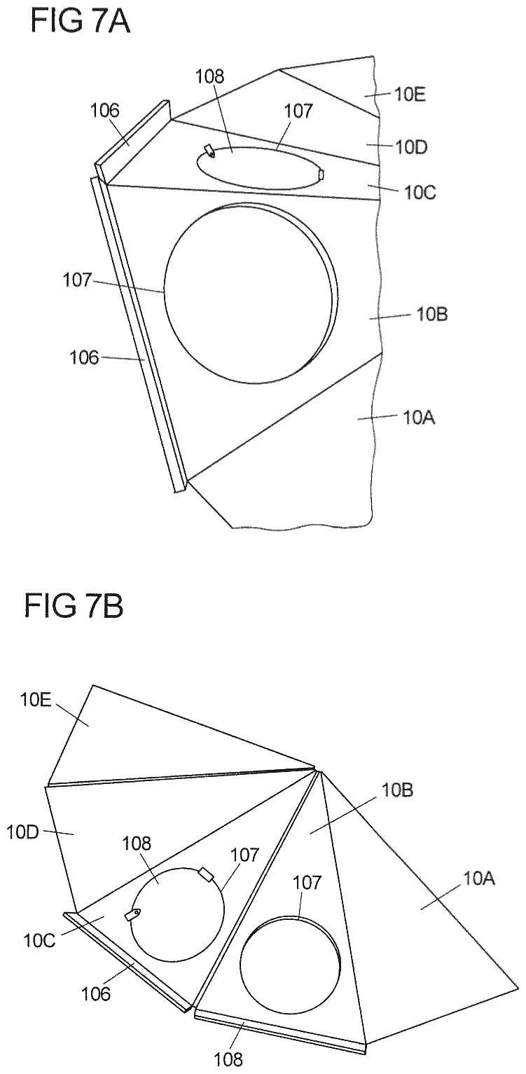

FIGS. 7A and 7B show two views of the segments 10A-10E of a folding table, e.g. of the folding table 1 of FIGS. 1-6 with five segments 10A-10E. In two of the segments 10B, 10C an opening 107 each is formed. In the present example, the opening 107 each is of circular design. Each of the openings 107 serves as a receptacle, e.g. is suited to accommodate a beverage container, such as a coffee mug. The openings 107 can be configured e.g. as a simple cutout in the segment, such as the opening 107 in the second segment 10B as shown in FIGS. 7A and 7B. Alternatively, one or more openings 107 can also be provided with a closure 108, such as the opening 107 in the third segment 10C as shown in FIGS. 7A and 7B. The closure 108 is pivotally articulated to the segment 10C by means of a hinge or joint indicated in the Figures. Optionally, a likewise indicated latch or slide is provided, which locks the closure 108 in a position closing the opening 107.

According to FIGS. 7A and 7B, the folding table can be provided with one or more limiters 106. Each of the limiters 106 is arranged at an edge of the storage surface AF. In the present example, the limiters 106 each are arranged at (and along) an outer edge 100 of a segment 10B, 10C. A limiter 106 can be fixed to a segment. In the illustrated example, each of the limiters 106 substantially perpendicularly protrudes from the segment 10B, 10C along the outer edge 100. Objects deposited on the storage surface AF thus can be secured against falling down. Optionally, each of the segments 10A-10E are provided with a limiter 106.

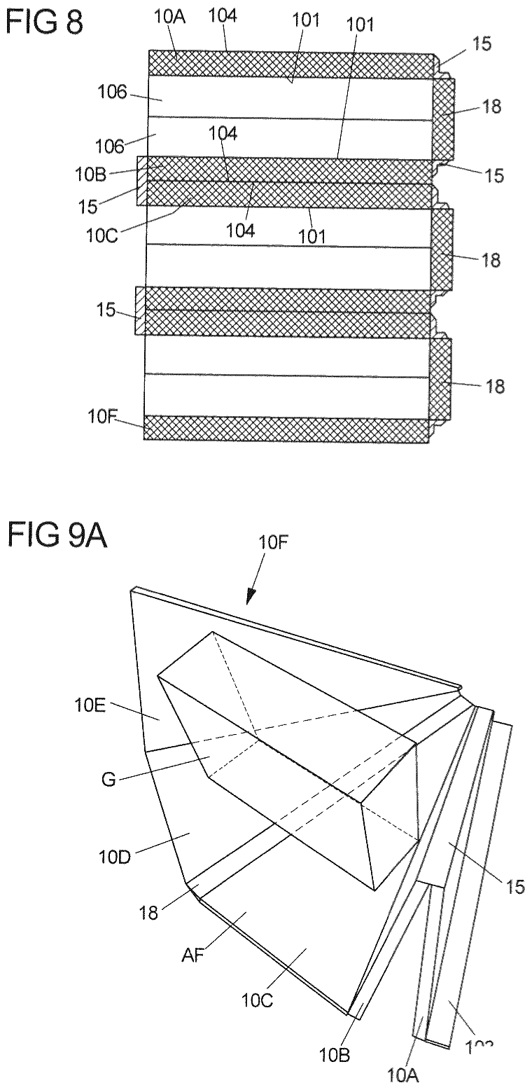

FIG. 8 shows a schematic representation of the segments 10A-10F (in the present example six segments) of a folding table, e.g. of the folding table 1 of FIGS. 1-6, wherein each of the segments 10A-10F is provided with a limiter 106 at its outer edge 100. The segments 10A-10F each are alternately articulated to each other by means of a hinge 15 or by means of two hinges 15 and by interposition of an intermediate piece 18. Due to the three intermediate pieces 18 in the present case, the surfaces 101 of adjacent segments facing each other are spaced apart from each other in the folded state so that there is room for the limiters 106. Undersides 104 of adjacent segments pivotally articulated to each other flatly rest against each other.

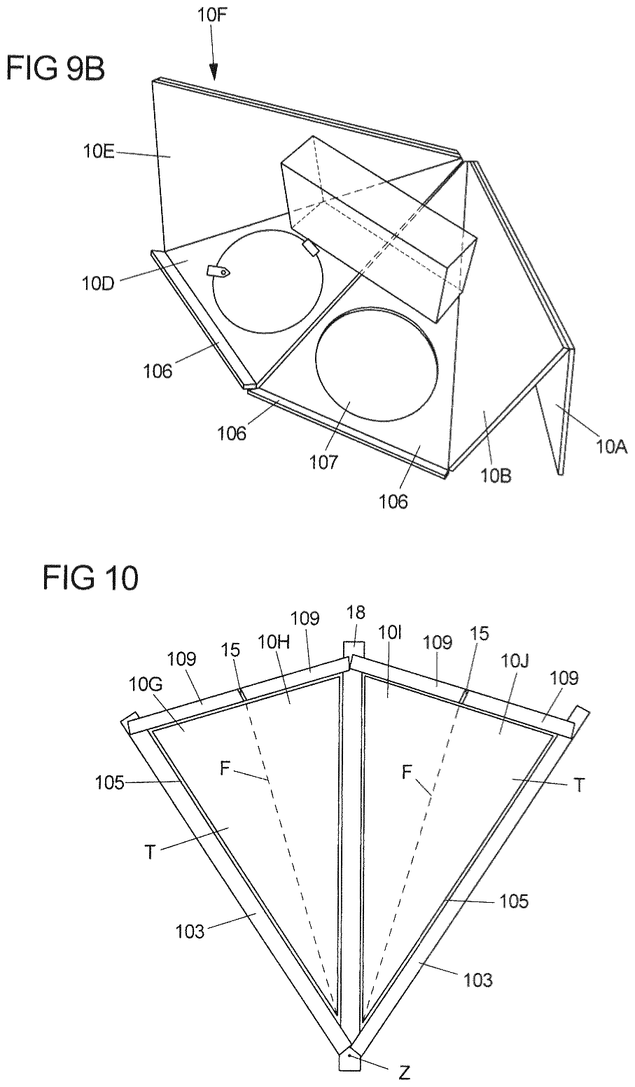

FIG. 9A shows the segments 10A-10F of the folding table 1 of FIGS. 1-6 in a partly unfolded state. Two of the segments 10C, 10D are aligned in a plane (and unfolded) and jointly form a storage surface AF. The remaining segments 10A, 10B, 10E, 10F are attached at an angle to the storage surface AF, for example folded up (almost) in pairs. The folded segments thus form a lateral boundary, whereby an object G, e.g. a mobile phone, can be fixed. This condition, in which some segments are unfolded, whereas other segments are folded, can be achieved for example simply by the weight of the object G or by manually pressing down some of the segments, e.g. the two middle segments 10C, 10D. Alternatively, several segments are pretensioned relative to each other, e.g. by means of a spring, so that first a part of the segments is unfolded, before the arms 103 unfold all of the segments 10A-10F.

FIG. 9B shows segments 10A-10F of a folding table, e.g. of the folding table 1 of FIGS. 1-6, which are provided with outer limiters 106, a fixing function corresponding to FIG. 9A and openings 107 as cup holders.

FIG. 10 shows an exemplary embodiment of segments 10G-10J of a folding table, e.g. of the folding table 1 of FIGS. 1-6, which each comprise a textile T. The textile T is mounted to fixed elements. Each of the segments 10G-10J furthermore may include a cross-beam 109. The cross-beams 109 are pivotally articulated to each other at their ends by means of hinges 15. The hinge 15 for example can be a portion of the textile T. Outer lateral edges 105 of the textile T of the outer segments 10G, 10J are attached to the arms 103. The pieces of textile T each are attached to the intermediate piece 18 (alternatively a single, continuous piece of textile is provided). Optionally, the textile T also is attached to the cross-beams 109.

By folding back the arms 103 (corresponding to the folding table 1 of FIGS. 1-6) a storage surface is spread out, which chiefly is formed by the textile T. Two adjacent segments each comprise a section of a coherent piece of textile T. On folding up, this textile T is folded along a folding line F. The folding lines F are aligned towards a concentric point Z.

The textile T can be elastic (and be tensioned at least in the unfolded state). Optionally, a 3D textile and/or a knitted spacer fabric is provided on the textile, e.g. to achieve a dampening effect. Cords, wires and/or cables can be incorporated or mounted, for example sewn, into the textile T, e.g. for strength increase.

According to each described embodiment, the outer edges 100 can be designed in the shape of a circular arc, instead of being rectilinear, so that the storage surface represents a circle or (more exactly) a circular segment.

The folding table 1 furthermore can be adjustable in height, e.g. by a height-adjustable bearing of the drive unit 14 and/or the rods 16, 17. Furthermore, a plurality of folding tables can be combined so that a plurality of planes of storage surfaces AF are formed in order to provide a larger storage space. The plurality of folding tables can be operatively connected to the same drive unit 14.

The storage surface AF can be provided with an anti-slip coating, e.g. a rubber coating. Furthermore, it can be provided that in the unfolded state one segment or several segments is/are adjustable with respect to the remaining segments in order to clamp objects, e.g. a mobile phone, in position.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1 folding table

10A-10J segment

100 outer edge

101 upper side

102 lateral edge

103 arm

104 underside

105 outer lateral edge

106 limiter

107 opening

108 closure

109 cross-beam

11 base

12 shifting element

13 connecting member

14 drive unit

15 hinge

16 rod

160 fixing point

17 rod

170 fixing point

171 guide rail

18 intermediate piece

2 vehicle interior lining

20 receptacle

21 closure

3 motor vehicle

30 steering wheel

AF storage surface

F folding line

G object

S1-S6 pivot axis

Z concentric point

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A folding table for use in a motor vehicle and configured to change between a folded state and an unfolded state, the folding table comprising:
a plurality of segments extending between two outer lateral edges and each of the segments of the plurality of segments having an upper side and a lower side,
wherein in the unfolded state, the upper side of each of the segments jointly form a storage surface and the two outer lateral edges form a first angle, and
wherein in
the folded state, the two outer lateral edges form a second angle less than the first angle, and the segments of the plurality of segments lie one on top of the other such that at least one upper side of the plurality of segments faces another upper side of the plurality of segments and/or at least one underside of the plurality of segments faces another underside of the plurality of segments.

2. The folding table of claim 1, wherein each of the segments of the plurality of segments include at least one lateral edge and a first segment and a second segment of the plurality of segments are configured to pivotally articulate with respect to each other about the at least one lateral edge, and wherein in the unfolded state, the upper side of each of the segments of the plurality of segments are arranged about a common point.

3. The folding table of claim 1, wherein in the folded state, each of the segments of the plurality of segments are configured to pivot relative to each other in alternating directions.

4. The folding table of claim 1, wherein in the folded state, the segments are arranged to form a zigzag pattern.

5. The folding table of claim 1, wherein as the folding table changes from the folded state to the unfolded state the plurality of segments are fanned out.

6. The folding table of claim 1, wherein in the unfolded state, the storage surface and/or the upper side of each of the segments of the plurality of segments each have a circular sector shape or triangular shape.

7. The folding table of claim 1, wherein in the unfolded state, the storage surface is substantially semicircular in shape.

8. The folding table of claim 2, wherein the first segment and the second segment are positively connected to each other at the at least one lateral edge.

9. The folding table of claim 1, wherein at least one segment of the plurality of segments is configured to pivotally articulate with respect to a base.

10. The folding table of claim 9, further comprising:
a shifting element configured to shift relative to the base; and
at least one connecting member configured to pivotally articulate with respect to the shifting element and pivotally connected to the segment.

11. The folding table of claim 1, further comprising a drive unit configured to transfer the folding table from the folded state to the unfolded state.

12. The folding table of claim 1, wherein each of the segments have substantially the same shape and/or size.

13. The folding table of claim 1, wherein at least one of the segments of the plurality of segments is formed of a textile that forms at least a portion of an upper side of the at least one segment.

14. A vehicle interior lining, comprising the folding table of claim 1.

15. The vehicle interior lining of claim 14, wherein the interior lining defines a receptacle configured to accommodate the folding table when the folding table is in the folded state.

16. (canceled)

17. A folding table for use in a motor vehicle and configured to change between a folded state and an unfolded state, the folding table comprising:
a base;
a rod extending from the base;
an arm pivotally connected to the base so that as the folding table moves from the folded state to the unfolded state, the arm pivots away from the rod; and
a first segment, a second segment, and a lateral edge extending therebetween, wherein the first segment and the second segment extend between the rod and the arm and when the folded table is in the folded state, the first segment and the second segment lie along one another.

18. The folding table of claim 17, wherein the first and second segments each pivot about a common pivot point defined by the base.

19. The folding table of claim 17, further comprising:
a shifting element configured to move along the rod as the folding table changes between the folded state and the unfolded state; and
a connecting member extending between and pivotally connected to the shifting element and the arm.

20. The folding table of claim 19, wherein the first segment defines an opening configured to receive a beverage container.

21. The folding table of claim 19, further comprising a closure pivotally attached to the first segment and configured to close the opening.
